(19) United States
(12) Patent Application Publication
(10) Pub. No.: US 2009/0066615 A1
(43) Pub. Date: Mar. 12, 2009

(54) DISPLAY APPARATUS AND DRIVING METHOD THEREOF

(75) Inventor: Somei Kawasaki, Saitama-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 12/203,482

(22) Filed: Sep. 3, 2008

(30) Foreign Application Priority Data
Sep. 11, 2007 (JP) 2007-235607

(51) Int. Cl. G09G 3/30

(52) U.S. Cl. 345/77

(57) ABSTRACT

A display apparatus comprises: plural light emitting devices emitting light by plural kinds of colors; a driving circuit for each light emitting device; a scanning line selecting the driving circuit; a light emission control line causing the light emitting devices to emit light; and a data line supplying to the selected driving circuit a current signal according to brightness, wherein the driving circuit comprises a driving transistor supplying a current, a first-switch between a gate of the driving transistor and the data line, a second-switch between a drain of the driving transistor and the light emitting device, a first-capacitor having one end connected to the gate of the driving transistor and the other end potential-fixed, and a second-capacitor connected to the gate of the driving transistor and the light emission control line, and a capacitance ratio of the second-capacitor to first-capacitor varies according to the color of the emitted light.

### BACKGROUND OF THE INVENTION

1. Field of the Invention

The present invention relates to a display apparatus in which an electroluminescence device (called an EL device, hereinafter) or the like for emitting light if a current is input is used for an image displaying operation, and a driving method for the display apparatus.

1. Description of the Related Art

U.S. Pat. No. 6,373,454 discloses that a driving circuit which is provided for EL devices of each pixel, and includes a driving transistor of an active matrix display apparatus of controlling light mission of each pixel by using a data line corresponding to a displaying pixel column and a scanning line corresponding to a displaying pixel row. Further, in this patent document, a current writing type driving circuit for reducing variations in thin film transistor characteristics generally used in driving circuits is proposed.

In the current writing type driving circuit, there is a problem that, since a convergence of a signal current flowing in the driving transistor is late when a small current corresponding to low brightness is written, the flowing signal current does not converge on an aimed writing current value during a given writing period. In this connection, U.S. Pat. No. 6,859,193 proposes a method of improving the above problem.

FIG. 13 is a diagram illustrating current-brightness characteristics of EL devices. More specifically, in FIG. 13, the X axis indicates a current which is input to the EL device, and the Y axis indicates light emission brightness. Here, it should be noted that the current-brightness characteristic illustrated in FIG. 13 is different with respect to a constituent material of each of the EL devices. More specifically, the EL device which performs red (R) light emission has the current-brightness characteristic indicated by EL1, the EL device which performs green (G) light emission has the current-brightness characteristic indicated by EL2, and the EL device which performs blue (B) light emission has the current-brightness characteristic indicated by EL3.

In general, the maximum brightness of each of R, G and B colors in a displaying device is set so as to display optimum white at a time when the R, G and B EL devices simultaneously emit light. The brightness L1 of the R EL device (EL1), the brightness L2 of the G EL device (EL2) and the brightness L3 of the B EL device (EL3) respectively illustrated in FIG. 13 are the brightness of the respective colors for displaying optimum white. That is, to display optimum white, the brightness L2 of the G EL device (EL2) is set to be higher than the brightness L1 of the R EL device (EL1), and brightness L1 of the R EL device (EL1) is set to be higher than the brightness L3 of the B EL device (EL3).

The input current with respect to the brightness of the R EL device (EL1) for emitting R light is indicated by I1, the input current with respect to the brightness of the G EL device (EL2) for emitting G light is indicated by I2, and the input current with respect to the brightness of the B EL device (EL3) for emitting B light is indicated by I3. Further, it should be noted that the input current I1 is set to be smaller than the input current I2, and the input current I2 is set to be smaller than the input current I3 (I1<I2<I3).

As just described, it is preferable that the signal currents of the R, G and B EL devices are all within a same modification range. However, the signal currents of the R, G and B EL devices have to be set respectively within different current ranges so as to acquire a white balance. Moreover, it is necessary to prepare a different current generating circuit for each color.

FIG. 14 is a diagram illustrating a driving circuit for supplying a current to each EL device.

In FIG. 14, signal lines P1 and P2 are in parallel with the row direction. More specifically, the signal line (scanning line) P1 is used to select a programming period, and the signal line (light emission control line) P2 is used to select a light emitting period. Also, a power source PVdd is connected to the driving circuit.

During a period that a high-level selection signal is supplied to the scanning line (signal line) P1 and thus both transistors M1 and M2 are on, a current signal is supplied from a data line DATA to a driving transistor M4, and the value of the supplied current signal is stored as an inter-terminal voltage of a capacitor Ch (a first capacitor) to be used for holding voltage.

Subsequently, if a low-level non-selection signal is supplied to the scanning line P1 and a high-level lighting signal is supplied to the light emission control line P2, the transistors M1 and M2 are turned off and a transistor M3 is turned on, whereby a current flows from the drain of the driving transistor M4 to the EL device EL3. Since the flowing current is determined on the basis of the gate-source voltage of the driving transistor M4, that is, the inter-terminal voltage of the capacitor Ch, this current is equivalent to the current which is input from the data line DATA. In this way, the current which is equivalent to the current signal flows in the EL device, and the EL device emits light with predetermined brightness. Incidentally, it should be noted that the EL device EL3 is grounded (CGND).

The switch (transistor) M3 which is connected between the drain of the driving transistor M4 and the EL device EL3 (light emitting device) is turned on and off in response to an exclusive signal supplied via the light emission control line P2 (hereinafter, this signal is also called “light emission control signal P2”), whereby it is possible to control turning on and off of the EL device EL3.

Here, it is assumed that a capacity of the capacitor Ch is given as C, a charging voltage of the capacitor Ch is given as V, and the signal current of the capacitor Ch is given as I. Under such conditions, a charging time t of the capacitor Ch can be given as t=CV/I.

In the circuit illustrated in FIG. 14, if the signal current is small, it takes a good amount of time to charge up a data signal to the storage capacitor Ch. That is, if brightness of the light emitting device is low, the signal current is small and it takes a good amount of time to perform a writing operation (that is, charging to the capacitor Ch), whereby the charging operation does not end within a given period. This is the above-described problem that the convergence of the turn-on current of the driving transistor deteriorates.

Among three colors R, G and B, the current signal for R is smallest. For this reason, if it is assumed that R, G and B are balanced in white display of maximum brightness, R firstly comes not to converge according to lowering of the brightness, and the brightness of R is further lowered as compared with those of other colors. Consequently, since R, G and B are unbalanced in dark gray display, the emitted light becomes colored visually.

As just described, such a method of holding the current signal in the pixels is called a current writing method, and a driving circuit for achieving the current writing method is called a current writing type driving circuit. In any case, in the current writing method, if an accidental error occurs between the white balance in the high-brightness white display and the white balance in the low-brightness white (gray) display, displayed image quality deteriorates.

### SUMMARY OF THE INVENTION

The present invention aims to provide a display apparatus which prevents aberration of a white balance in low-brightness display, which is caused due to differences in input current—brightness characteristics among EL devices of respective colors, and to provide a driving method of driving the display apparatus.

First, a first aspect of the present invention is characterized by a display apparatus comprising plural light emitting devices arranged in a row direction and a column direction, each of which emits light of a color selected from plural kinds of colors; a driving circuit connected to each of the plural light emitting devices; a scanning line for supplying a selection signal to select the driving circuits in the row direction; a light emission control line for supplying a light emission control signal to cause the light emitting devices in the row direction to emit light; and a data line for supplying a current signal designating brightness of the light emitting device to the selected driving circuits, wherein the driving circuit comprises a driving transistor which supplies a current to the light emitting device, a first switch which is arranged between a gate of the driving transistor and the data line, and is turned on in response to the selection signal on the scanning line, a second switch which is arranged between a drain of the driving transistor and the light emitting device, and is turned on in response to the light emission control signal on the light emission control line, a first capacitor one end of which is connected to the gate of the driving transistor, and a potential of the other end of which is fixed, and a second capacitor one end of which is connected to the gate of the driving transistor, and the other end of which is connected to the light emission control line, and a capacitance ratio of the second capacitor to the first capacitor varies according to the color of the light emitting device to which the driving circuit is connected. A second aspect of the present invention is characterized by a driving method for a display apparatus according to the above first aspect, the driving method comprising: holding the current signal on the data line as a voltage in the first capacitor of the driving circuit, by turning on the first switch; and supplying the current according to the voltage held in the first capacitor from the drain of the driving transistor to the light emitting device, by turning off the first switch and turning on the second switch.

According to the present invention, in case of achieving a white balance by adjusting a maximum current of the EL device of each color, it is unnecessary to change a signal current for each color. That is, it is possible to achieve the white balance by unifying the variable ranges of the signal currents of respective colors.

Further, according to the present invention, since the variable ranges of the signal currents of respective colors are unified, the constitution of the circuit for generating the signal current can be simplified.

Furthermore, according to the present invention, since the signal current can be made larger than the current flowing in the light emitting device, it is possible to perform the current writing without occurrence of an error even at low brightness. Therefore, it is possible to achieve the white balance irrespective of brightness.

Further features of the present invention will become apparent from the following description of exemplary embodiments with reference to the attached drawings.

### BRIEF DESCRIPTION OF THE DRAWINGS

FIG. 1 is a diagram illustrating a part of the display apparatus according to the present invention.

FIG. 2 is a diagram illustrating an example of the driving circuit for the display apparatus according to the present invention.

FIG. 3 is a timing chart of scanning signals for driving the driving circuit illustrated in FIG. 2.

FIG. 4A is a diagram illustrating the relation between a signal current and a driving current of the driving circuit illustrated in FIG. 2.

FIG. 4B is a diagram illustrating the relation between a signal current and a driving current of the driving circuit illustrated in FIG. 14.

FIG. 5 is a diagram illustrating a Vgs-Id characteristic of a transistor.

FIG. 6A is a diagram illustrating the relation between a signal current and a driving current of the driving circuit for R illustrated in FIG. 1.

FIG. 6B is a diagram illustrating the relation between a signal current and a driving current of the driving circuit for G illustrated in FIG. 1.

FIG. 6C is a diagram illustrating the relation between a signal current and a driving current of the driving circuit for B illustrated in FIG. 1.

FIG. 7A is a diagram illustrating the relation between a signal current and a driving current of a driving circuit for R in a comparative example.

FIG. 7B is a diagram illustrating the relation between a signal current and a driving current of a driving circuit for G in the comparative example.

FIG. 7C is a diagram illustrating the relation between a signal current and a driving current of a driving circuit for B in the comparative example.

FIG. 8 is a diagram illustrating an example of another driving circuit for the display apparatus according to the present invention.

FIG. 9 is a diagram illustrating a layout of the driving circuits for the display apparatus according to the present invention.

FIG. 10 is a diagram illustrating a layout of the light emitting devices for the display apparatus according to the present invention.

FIG. 11 is a cross section diagram illustrating the constitution along the line segment a1-a2 illustrated in FIG. 9.

FIG. 12 is a cross section diagram illustrating the constitution along the line segment b1-b2 illustrated in FIG. 9.

FIG. 13 is a diagram illustrating current-brightness characteristics of EL devices.

FIG. 14 is a diagram illustrating a conventional driving circuit for supplying a current to each EL device.

### DESCRIPTION OF THE EMBODIMENTS

Hereinafter, the exemplary embodiments of the present invention will be described in detail with reference to the attached drawings.

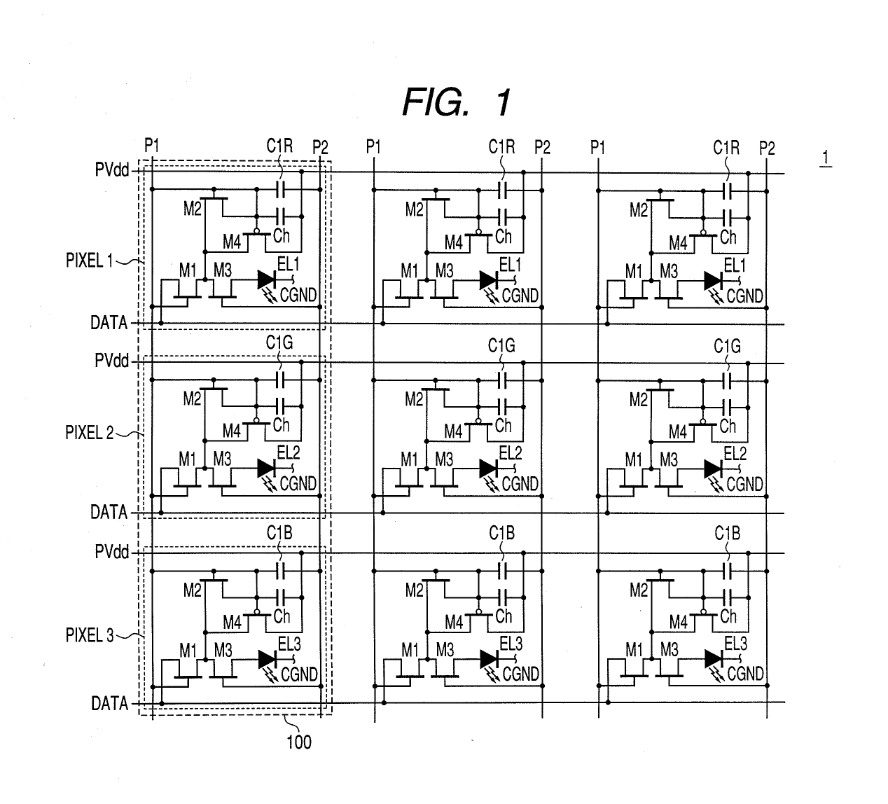

FIG. 1 is a diagram illustrating a part of the display apparatus according to the present invention.

In FIG. 1, a display apparatus 1 contains the displaying section on which plural pixels 100 are arranged like a matrix in a row direction (i.e., a vertical direction) and a column direction (i.e., a horizontal direction). Each pixel 100 includes plural light emitting devices which respectively emit light of different colors. In the following description, the light emitting element is assumed to be an EL device, and the different colors are assumed to be red (R), green (G) and blue (B) three colors.

The pixel 100 is constituted by a sub-pixel PIXEL1 which consists of an EL device EL1 for emitting red (R) light and the driving circuit for driving the EL device EL1, a sub-pixel PIXEL2 which consists of an EL device EL2 for emitting green (G) light and the driving circuit for driving the EL device EL2, and a sub-pixel PIXEL3 which consists of an EL device EL3 for emitting blue (B) light and the driving circuit for driving the EL device EL3.

A scanning line P1 and a light emission control line P2 which together connect the driving circuit of each row are arranged in the row direction of the displaying section, and a data line DATA and a power source line PVdd are arranged for each column of the sub-pixel in the column direction of the display section. Here, the data line DATA is connected to the driving circuit of each column to supply the current signal to the driving circuit.

A driving transistor M4 which supplies the current to the EL device is provided in the driving circuit, the source of the driving transistor M4 is connected to the power source line PVdd, and the drain of the driving transistor M4 is connected to the anode of the EL device through the transistor M3.

Transistors M1 and M2 are arranged in series between the gate of the driving transistor M4 and the data line DATA. Here, each of the transistors M1 and M2 acts as the switch which is turned on in response to the selection signal (i.e., a high level signal) on the scanning line P1, and thus the transistors M1 and M2 constitute one switch (called a first switch) which is turned on and off between the gate of the driving transistor M4 and the data line DATA.

The transistor M3 which is arranged between the drain of the driving transistor M4 and the light emitting device acts as the switch (called a second switch) which is turned on in response to a lighting signal (i.e., a high level signal) on the light emission control line P2.

A capacitor Ch (i.e., a first capacitor), which is arranged between the gate of the driving transistor and the power source line PVdd, holds as the voltage the current signal which is supplied from the data line DATA to the driving circuit. Further, a capacitor C1 (i.e., a second capacitor) is arranged between the gate of the driving transistor M4 and the light emission control line P2.

In FIG. 1, the second capacitor C1 is different for each of the driving circuits. More specifically, a capacitor C1R is provided for the driving circuit PIXEL1 for the R EL device, a capacitor C1G is provided for the driving circuit PIXEL2 for the G EL device, and a capacitor C1B is provided for the driving circuit PIXEL3 for the B EL device. On the other hand, the first capacitor Ch for each of the three driving circuits PIXEL1, PIXEL2 and PIXEL3 has identical capacitance.

Subsequently, the operation of the driving circuit illustrated in FIG. 1 will be described.

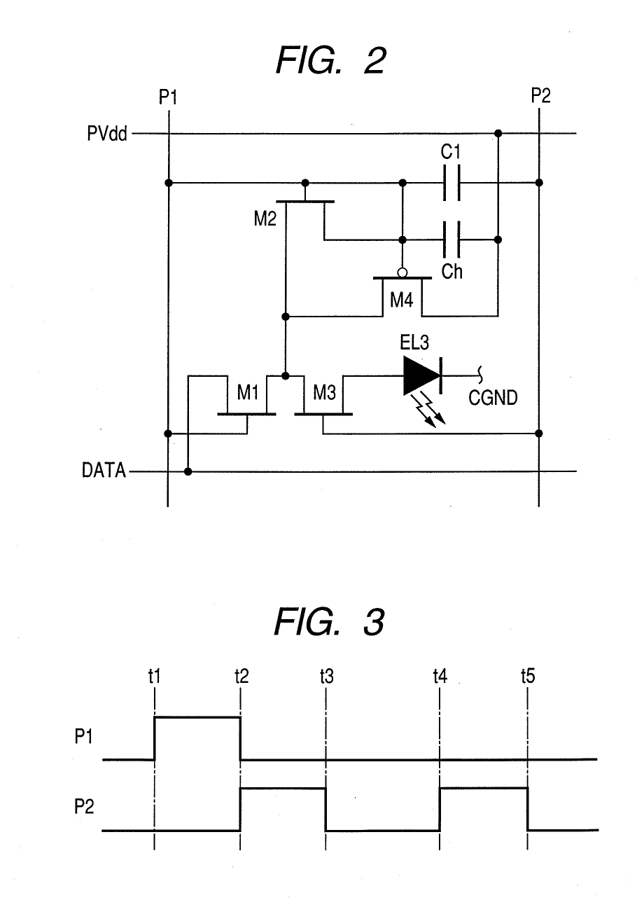

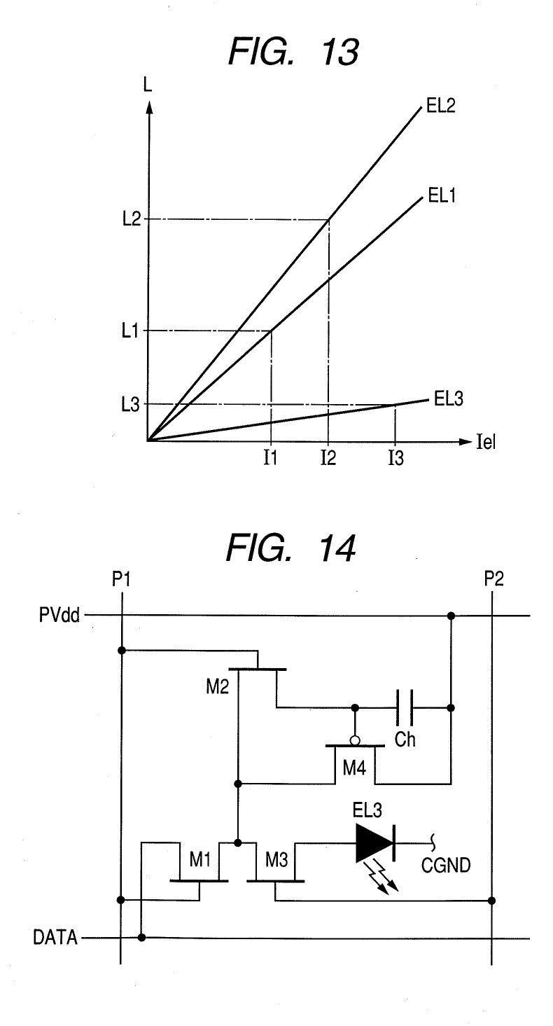

FIG. 2 is a diagram illustrating an example of one of the driving circuits illustrated in FIG. 1. In FIG. 2, it should be noted that suffixes “R”, “G” and “B” which are added to discriminate the sub-pixels of the respective colors in FIG. 1 will be omitted for simplicity, and that the same constituents elements as those in FIG. 14 are described with the same reference numerals and symbols respectively.

The driving circuit illustrated in FIG. 2 is different from that illustrated in FIG. 14 in the point that a second capacitor C1 for voltage correction is connected among the gate of a transistor M4, a scanning line P1 and a light emission control line P2.

FIG. 3 is a timing chart for describing the operation of the driving circuit illustrated in FIG. 2.

In FIG. 3, since a scanning signal P1 (i.e., a signal on the scanning line P1) is on an H (high) level and a light emission control signal P2 (i.e., a signal on the light emission control line P2) is on an L (low) level at a time t1, switches M1 and M2 are turned on, and a switch M3 is turned off. Consequently, the transistor M4 comes to establish a diode connection and is connected to a data line DATA.

If a signal current Ip (not illustrated in FIGS. 2 and 3) is supplied to the data line DATA, a turn-on current of the transistor M4 changes so as to converge on the signal current Ip. A gate-source voltage for determining the turn-on current of the transistor M4 is held in a capacitor Ch (i.e., a first capacitor) for holding voltage.

The level of the scanning signal P1 changes from the H level to the L level at a writing end time t2, and the level of the light emission control line P2 changes from the L level to the H level. Consequently, since the characteristics of the switches M1, M2 and M3 can be aligned, it can be assumed that a voltage shift (change) width of the scanning signal P1 is equivalent to a voltage shift of the light emission control signal P2. At this time, since the second capacitor C1 is present, the gate potential of the transistor M4 changes from the value immediately before the writing end time t2, by a voltage (or a voltage shift) ΔV indicated by the following equation (1).

ΔV=Vp×C1/(Ch+C1) (1)

where, Vp indicates the voltage shift of the scanning signal P1 and the light emission control signal P2.

Since such a voltage shift ΔV has a positive value, the gate potential shifts toward a higher level. As a result, since the gate-source voltage of the transistor M4 changes toward a smaller absolute value, the drain current reduces as compared with the writing end time (i.e., immediately before the time t2). As indicated by the equation (1), the magnitude of the voltage ΔV can be adjusted based on the capacitance ratio of the second capacitor C1 to the first capacitor Ch.

As described below, since the signal current Ip is set to have the larger value as compared with the value of the driving current for the EL device (hereinafter, called the EL device driving current), a time up to the convergence of the current of the transistor M4 to the signal current Ip is shortened. Even if the EL device driving current is small, the convergence ends during a period from the time t1 to the time t2 by setting the signal current Ip to a sufficiently large value.

After the time t2, the EL device starts to emit light. After then, the EL device is controlled to emit light or stop emitting light in response to the light emission control signal P2.

If the light emission control signal P2 is on the L level at a time t3, the current is not supplied to the EL device, whereby the EL device stops emitting light. If the light emission control signal P2 is on the H level from a time t4 to a time t5, the current is supplied to the EL device as well as the operation from the time t2 to the time t3, whereby the EL device again starts to emit light. Then, since the light emission control signal P2 is again on the L level at the time t5, the current is not supplied to the EL device, whereby the EL device stops emitting light.

The change of the gate-source voltage indicated by the equation (1) occurs at the same time the EL device starts to emit light in response to the signal supplied from the light emission control line. Thus, it is assured that the EL device emits light with the current according to the post-change gate-source voltage.

With respect to the change of the light emission control line before and after the EL device emits light by turning on the second switch, it is necessary to change the gate-source voltage of the driving transistor toward a smaller absolute value. In the circuit illustrated in FIG. 2, since the driving transistor is a p-channel type transistor, it is necessary to change the voltage shift Vp of the light emission control signal toward higher gate potential, that is, from the L level to the H level. For this reason, the second switch is constituted by an n-channel type transistor.

If the driving transistor is an n-channel type transistor, it is necessary to change the voltage shift Vp of the light emission control signal toward lower gate potential, that is, from the H level to the L level. For this reason, the second switch is constituted by a p-channel type transistor. As just described, in a case where the second switch is constituted by a transistor, a transistor which has a channel polarity opposed to that of the driving transistor is used as the relevant transistor.

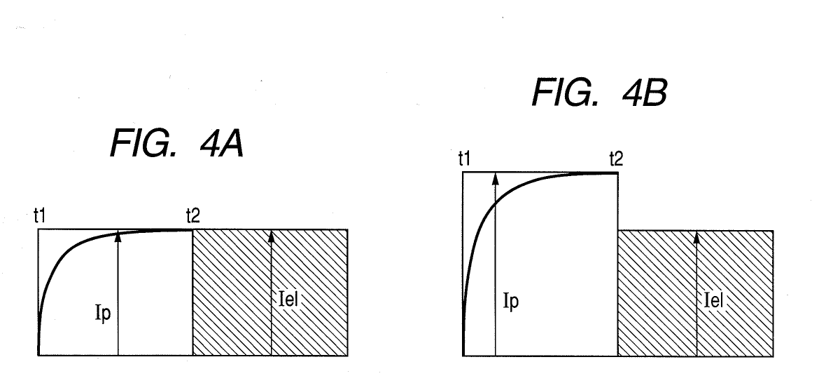

Each of FIGS. 4A and 4B is a diagram illustrating the relation between a current Ip flowing in the transistor M4 being in the current writing operation from the time t1 to the time t2 and a current Iel flowing in the transistor M4 when the light emission control signal P2 is on the H level from the time t2 to the time t3. More specifically, FIG. 4A indicates the state of the circuit having no second capacitor C1 in FIG. 14, and FIG. 4B indicates the state of the circuit having the second capacitor C1 in FIG. 2.

As described above, if the second capacitor C1 is present, the absolute value of the gate-source voltage of the transistor M4 decreases at the time t2, whereby the drain current decreases. Therefore, by using such a phenomenon, the signal current on the data line can be made larger than the current to be supplied to the EL device.

Here, the signal current Ip in FIG. 4B is made larger than that in FIG. 4A so that the current Iel at and after the time t2 is made equivalent between FIGS. 4A and 4B.

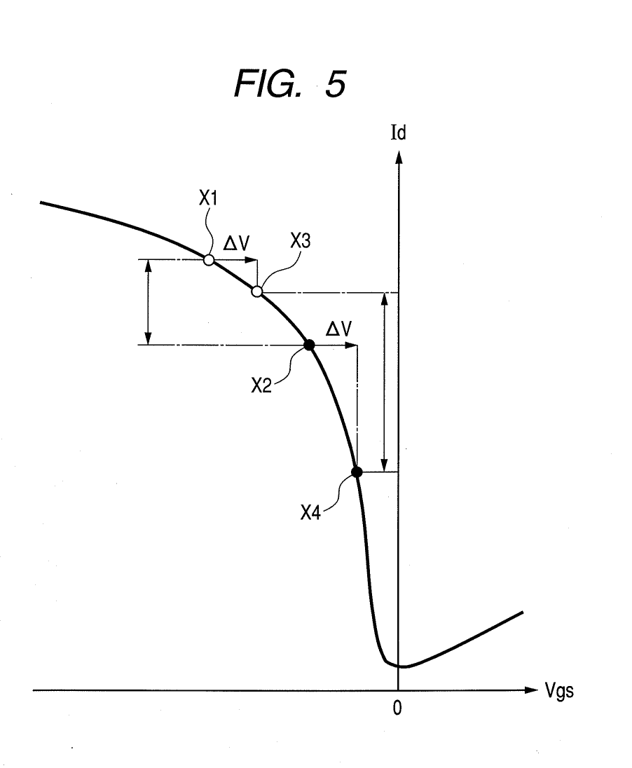

FIG. 5 is a diagram illustrating the relation between a gate-source voltage Vgs (horizontal axis) and a drain current Id (vertical axis) of the driving transistor M4. Here, it should be noted that the horizontal axis is plotted by a logarithmic scale.

It is assumed that the operation range when the current writing is performed to the transistor M4 is set between operation points X1 to X2. Here, the operation point X1 is the point of maximum current, and the operation point X2 is the point of minimum current.

If the second capacitor C1 is present, since the gate potential of the driving transistor M4 increases by ΔV at the time t2, the gate-source voltage Vgs decreases. As a result, the operation points X1 and X2 of the transistor M4 respectively shift to operation points X3 and X4 when driving, and the currents at the operation points X3 and X4 are smaller than those at the operation points X1 and X2 respectively. This is described in FIG. 4B.

It can be understood from FIG. 5 that the current flowing from the transistor M4 to the EL device when driving the EL device is extremely smaller than the turn-on current Ip when current writing. Further, in FIG. 5, the two vertical arrows indirectly indicate the ratio of the maximum current and the minimum current before and after the gate potential shifts. Here, it can be understood from these arrows that the ratio after the shift is larger than the ratio before the shift.

That is, it is possible by the driving circuit having the second capacitor C1 to shift the dynamic ranges of the signal current and the EL device driving current so as to make the signal current Ip given to the data line DATA larger than the EL device driving current Iel. In other words, the signal current Ip given to the data line DATA is supplied to the driving circuit, held as the voltage in the first capacitor Ch, and has the value larger than that of the current (EL current) supplied from the driving transistor to the EL device according to the held voltage.

The ratio of the signal current and the EL current is determined based on the voltage shift ΔV, and this ratio is substantially constant irrespective of the magnitude of the signal current.

Since the signal current can be made large even if the brightness of the EL device is low and the EL current is small, a delay of the current writing operation due to a large parasitic capacitance of the data line can be reduced.

Moreover, even if a low-brightness signal is input and thus the EL driving current Iel is extremely small, the writing current Ip to the EL driving current Iel can be set with a magnification higher than a case of a high-brightness signal. Since the dynamic range of the EL driving current Iel can be made large as compared with the signal current Ip, a contrast ratio of a surface image can be improved.

As described above, if the second capacitor C1 is provided in the driving circuit, it is possible to shift the dynamic ranges of the signal current and the EL device driving current and thus make the signal current large. The present invention intends to change the magnitude of such shift according to the color of the light emitting device. In the following, such an operation of the present invention will be described in detail.

<Relation Between Driving Circuit and Capacitor C1 for Each Color>

In order to cause the R, G and B EL devices to emit light as achieving white balance, it is necessary to set the EL driving currents for the respective colors to satisfy determined ratios as indicated by I1, I2 and I3 in FIG. 13. In the circuit illustrated in FIG. 1, the ratios of the second capacitor C1 to the first capacitor Ch, i.e., C1R/Ch, C1G/Ch and C1B/Ch, are adjusted independently to determine the voltage shift amounts ΔV for the respective colors, thereby enabling the current at the time of the voltage shift to be the predetermined currents (I1, I2 and I3 illustrated in FIG. 13).

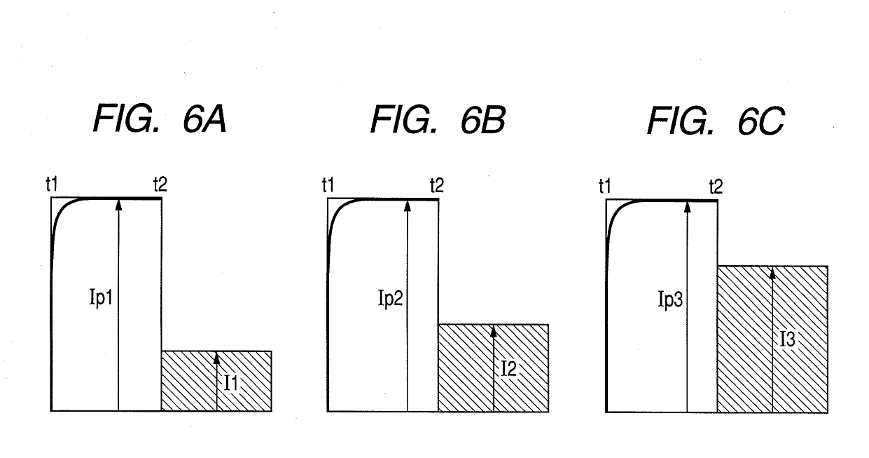

In FIG. 1, the magnitudes of the capacitors C1 of the R, G and B driving circuits are set in the order C1R>C1G>C1B. The voltage shift amounts ΔV for the respective colors indicated by the equation (1) have the positive values, and the order thereof is ΔV(R)>ΔV(G)>ΔV(G). FIGS. 6A, 6B and 6C respectively indicate the relations of the signal currents of R, G and B and the EL driving current at this time.

The values of the capacitors C1R, C1G and C1B are determined as follows.

First, the level of the signal current Ip is fixed, and the ratios I1/Ip, I2/Ip and I3/Ip of the respective EL driving currents I1, I2 and I3 to the signal current Ip are determined. Then, it is possible by these ratios to determine the voltage shift amounts ΔV(R), ΔV(G) and ΔV(G) for the respective colors based on the characteristic illustrated in FIG. 5. If the voltage shift amounts are determined, it is possible by the equation (1) to obtain the ratios C1R/Ch, C1G/Ch and C1B/Ch respectively. Since the magnitude of the capacitor Ch for holding voltage has been determined based on more basic specifications such as a size of the display apparatus, a driving voltage and the like, it is thus possible to determine the values of the capacitors C1R, C1G and C1B respectively.

As just described, in the present invention, the capacitance of the capacitor C1 is made different for each color, whereby the gate-source voltage of the driving transistor is changed with the magnitude different for each color. The capacitance of the capacitor C1 of the driving circuit for each color is determined based on the maximum current flowing in each of the R, G and B EL devices, that is, the magnitude of the current of each of the R, G and B EL devices when white is displayed. The capacitance of the capacitor C1 or the capacitance ratio of the capacitors C1 and Ch is determined so that the color of the large maximum current corresponds to the small voltage shift ΔV, that is, the voltage shift ΔV increases according as the maximum current decreases. The order of the capacitances of the capacitors C1 or the capacitance ratios of the capacitors C1 and Ch for the respective colors coincides with the magnitudes of the maximum currents.

Although the maximum currents to be supplied to the EL devices of the respective colors to achieve white balance are different according to the EL devices of the respective colors, the variable ranges of respective signal currents Ip1 for R, Ip2 for G and Ip3 for B can be aligned, whereby the constitutions of the circuits for generating the respective signal currents can be simplified.

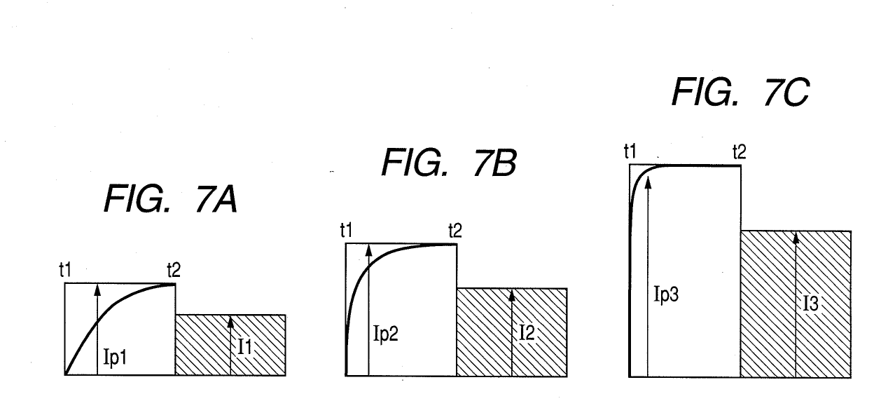

If the capacity of the capacitor C1 is made common to the respective colors, that is, C1R/Ch=C1G/Ch=C1B/Ch is set, the voltage shift is in common with the respective colors, and only the magnitude thereof can be adjusted. FIGS. 7A, 7B and 7C respectively indicate the relations of the signal currents of R, G and B and the EL driving current at this time. As illustrated, the ranges of the signal currents of the respective colors R, G and B cannot be aligned. For this reason, since it is necessary to add a function of generating signals of different ranges to a signal generation circuit, the constitution of the circuit is complicated.

Further, as illustrated in FIG. 7C, since the EL driving current Iel=I3 is large in the B EL device, the signal current Ip3 is also large, whereby the convergence of the turn-on current of the driving transistor is good in the writing period. On the other hand, in the R EL device as illustrated in FIG. 7A, since the EL driving current Iel=I1 is small, the signal current Ip1 is also small, whereby the convergence of the turn-on current of the driving transistor is bad in the writing period. If the ranges of the signal currents are aligned as illustrated in FIGS. 6A to 6C, unbalance in the convergence among the R, G and B three colors is eliminated.

<Another Driving Circuit>

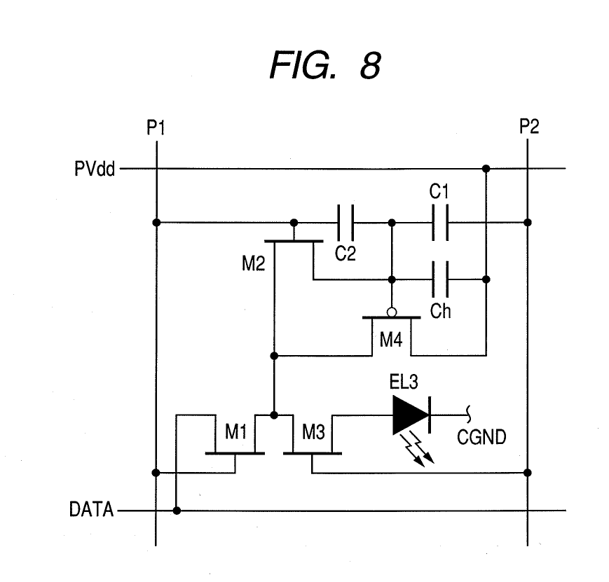

FIG. 8 is a diagram illustrating another driving circuit which is obtained by further adding another capacitor C2 (called a third capacitor) to the driving circuit illustrated in FIG. 2. The third capacitor C2 is arranged between the gate of a driving transistor M4 and a scanning line P1. If the driving circuit is operated at the driving timing illustrated in FIG. 3, a selection signal (H level) on the scanning line P1 is switched to a non-selection signal (L level) at the time t2, and a turn-off signal on the light emission control line is switched to a turn-on signal. At this time, a change of the gate-source voltage of the driving transistor M4 is given by the following equation (2).

ΔV=Vp×(C1−C2)/(Ch+C1+C2) (2)

Here, a sign of the voltage shift ΔV, i.e., a direction of the voltage shift, can be changed based on the magnitude relation of the capacitors C1 and C2. Moreover, the EL driving currents of the respective colors can be made different by making the magnitude of the capacitor C2 different in the respective R, G and B driving circuits.

<Circuit Layout>

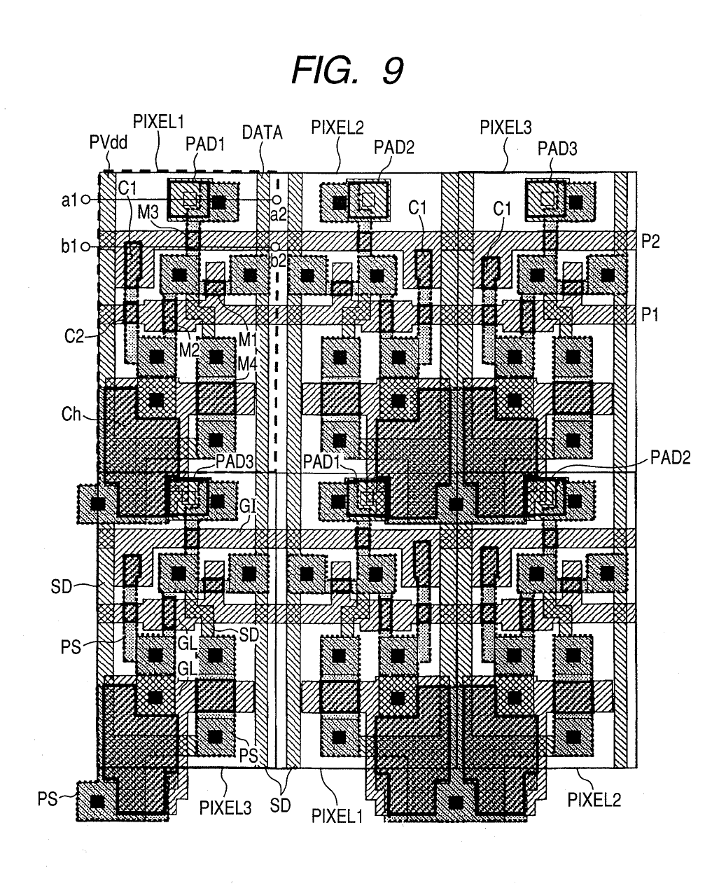

FIG. 9 is a diagram illustrating a layout of the driving circuits each illustrated in FIG. 8 are arranged on a substrate. In FIG. 9, the respective circuit components of one driving circuit, that is, transistors M1 to M4 and capacitors Ch, C1 and C2, are arranged within the region circumscribed by the dotted line.

The capacitors Ch, C1 and C2 are formed on the region where the gate wiring layer indicated by the up-to-right oblique lines and the polysilicon layer indicated by the shadows overlap each other. The capacitor Ch is formed on the overlap region of the gate wiring layer extended from the gate electrode of the driving transistor M4 and the polysilicon layer, and the capacitor C2 is formed on the region where the scanning line P1 and the polysilicon layer extended from the drain of the transistor M2 intersect with each other. Each of the capacitor Ch and the capacitor C2 has the same overlap area in each of driving circuits PIXEL1 to PIXEL3, and the capacitance values of these capacitors are aligned. Namely, ChR=ChG=ChB, and C2R=C2G=C2B are satisfied.

Incidentally, in case of constituting the driving circuit illustrated in FIG. 1 having no third capacitor C2, the position of the scanning line P1 is replaced with the position of the light emission control line P2 in FIG. 8, or the wiring of the scanning line P1 is diverted. Namely, the layout of the driving circuit is changed so that the scanning line P1 does not intersect with the polysilicon layer extended from the drain of the transistor M2.

The capacitor C1 is formed on the overlap region of the light emission control line P2 and the polysilicon layer extended from the drain of the transistor M2. The area of the polysilicon layer on the overlap region is different for each of the driving circuits PIXEL1 to PIXEL3, that is, the area is maximum for the driving circuit PIXEL1 and is minimum for the driving circuit PIXEL3. Since each of the driving circuits PIXEL1 to PIXEL3 drives each of the R, G and B EL devices, the magnitudes of the capacitors C1 of these circuits are set in the order of R, G and B. Namely, C1R>C1G>C1B is satisfied.

Here, spaces PAD1, PAD2 and PAD3 for making contact holes for connection with the EL devices are provided respectively on the driving circuits PIXEL1, PIXEL2 and PIXEL3.

A power source line PVdd and a data line DATA are wired by a source-drain wiring layer SD being the same layer of the source-drain electrode indicated by the up-to-left oblique lines in FIG. 9.

The transistors M1 to M4 and the capacitors Ch, C1 and C2 are formed on the region where an upper-layer gate wiring layer and a lower-layer polysilicon layer PS overlap each other via a gate insulating layer.

An ionic species which is different from that for the polysilicon layer PS constituting another n-type transistor is doped to the polysilicon layer PS including the p-type transistor M4.

The polysilicon layer PS which forms the capacitors Ch, C1 and C2 has been made conductive by high-level ion doping, as well as the source region and the drain region of each transistor.

In FIG. 9, the driving circuit PIXEL1 for the R EL device, the driving circuit PIXEL2 for the G EL device and the driving circuit PIXEL3 for the B EL device are arranged in two lines. More specifically, in the first line, these circuits are arranged in the direction of the scanning line P1 in the order of R, G and B. Then, in the next line, these circuits are arranged in the order of B, R and G. Such an arrangement of the driving circuits is relative to the arrangement of the EL devices provided above the driving circuits.

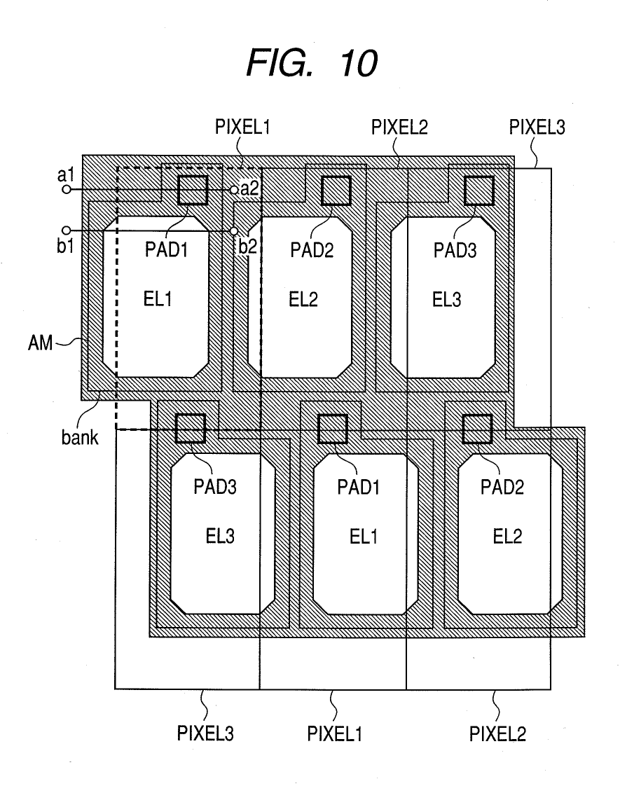

FIG. 10 is a diagram illustrating the arrangement of the light emitting devices which are connected to the driving circuit illustrated in FIG. 9. In FIG. 10, since the pixels of each color are delta-arranged, the positions of the driving circuits aligned in the row direction are shifted from the positions of the driving circuits aligned in the column direction.

Incidentally, the driving circuits PIXEL1, PIXEL2 and PIXEL3 are illustrated simply as rectangles in FIG. 10. Further, an anode electrode AM of the EL device is connected to the driving circuits.

Above the anode electrode AM, a pixel separation layer “bank” is formed on the range indicated by shadows to separate the light emitting regions for the respective colors from others.

<cross section constitution of line segment a1-a2>

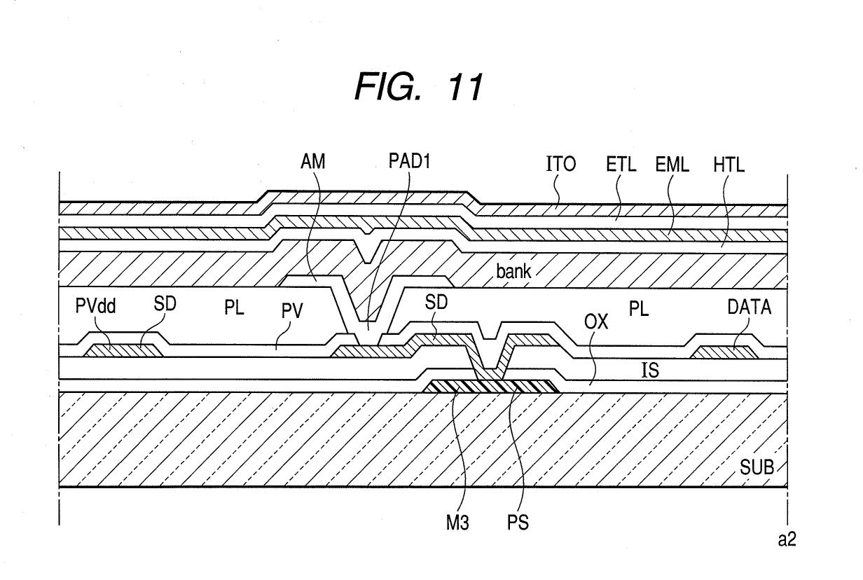

FIG. 11 is a cross section diagram illustrating the constitutions of the light emitting device and the driving circuit, along the line segment a1-a2 of FIG. 9 (also, the line segment a1-a2 of FIG. 10 is drawn at the same position). In other words, FIG. 11 illustrates the cross sections of the drain terminal of the transistor M3, the data line DATA and the power source line PVdd.

The drain region of the transistor M3 is formed by the polysilicon layer PS on a substrate SUB, and a gate insulating layer OX is provided thereon. The wiring region which is connected to the data line DATA and the power source line PVdd consisting of the source-drain wiring layer SD and the space PAD1 is provided via an interlayer insulating layer IS. A protective layer PV is provided on the source-drain wiring layer SD, and a planarizing layer PL is further provided on the protective layer PV. The anode electrode layer AM is provided on the planarizing layer PL, the pixel separation layer “bank” is provided on the anode electrode layer AM, and a hole transport layer HTL, a light emitting layer EML, an electron transport layer ETL and a cathode transparent conductive layer ITO for constituting the EL device are formed on the pixel separation layer “bank”. However, at the line segment a1-a2, any light emission cannot be performed because the pixel separation layer “bank” exists below the hole transport layer HTL.

<Cross Section Constitution of Line Segment b1-b2>

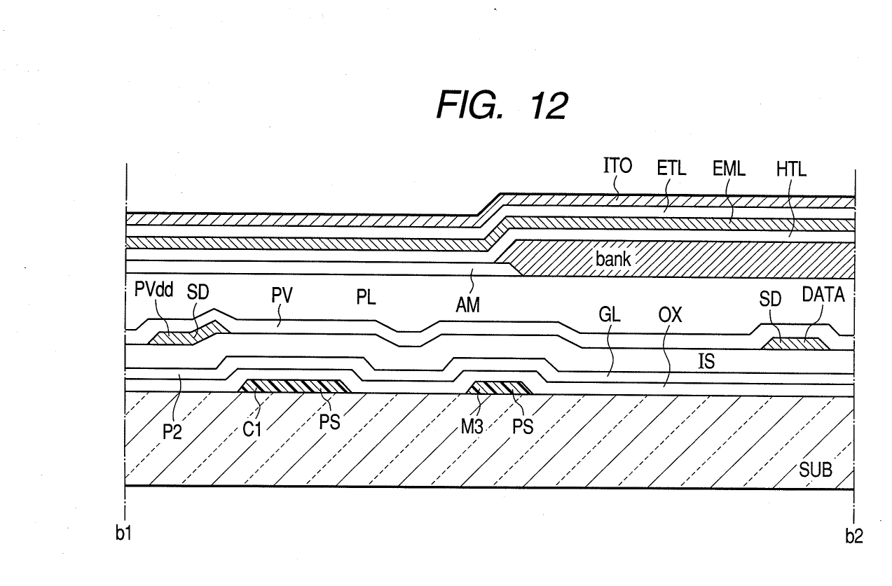

FIG. 12 is a cross section diagram illustrating the section constitution along the line segment b1-b2 of FIGS. 9 and 10. It should be noted that the diagram of FIG. 12 includes the sections of the capacitor C1 and the transistor M3.

In FIG. 12, the lower electrode of the capacitor C1 and the channel region of the transistor M3 are formed by the polysilicon layer PS on the substrate SUB. The light emission control line P2 consisting of a gate wiring layer GL is formed via the gate insulating layer OX, and the data line DATA and the power source line PVdd consisting of the source-drain wiring layer SD are formed via the interlayer insulating layer IS on the light emission control line P2. Here, the vertical constitution above the source-drain wiring layer SD is the same as that in case of the line segment a1-a2. Light emission is performed in the region with which the hole transport layer HTL and the anode electrode layer AM are in contact. Incidentally, it should be noted that the vertical constitution illustrated in FIG. 11 is a top-emission type.

The region of the gate wiring layer GL forming one electrode of the capacitor C1 is larger than the region of the polysilicon layer PS forming the other electrode of the capacitor C1, the capacitance of the capacitor C1 can be freely set by appropriately determining the area of the polysilicon layer PS.

The above embodiment is directed to the so-called top-emission type light emission display apparatus that light is emitted from the side opposite to the substrate. However, the present invention is applicable to a so-called bottom-emission type light emission display apparatus that light is emitted through a substrate.

Further, the EL device may be a type of using the cathode as the common electrode and a type of using the anode as the common electrode. Furthermore, the transistor in the driving circuit can use a p-channel type and an n-channel type.

In the above description, one end of the capacitor C1 is connected to the gate of the driving transistor M4, and the other end of the capacitor C1 is connected to the light emission control line P2. However, the present invention is not limited to this. That is, another type of capacitor may be used if it changes the gate-source voltage of the driving transistor M4 toward a lower absolute value during a lighting on period.

While the present invention has been described with reference to the exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2007-235607, filed Sep. 11, 2007, which is hereby incorporated by reference herein in its entirety.

What is claimed is:

1. A display apparatus comprising:
plural light emitting devices arranged in a row direction and a column direction, each of which emits light of a color selected from plural kinds of colors;
a driving circuit connected to each of the plural light emitting devices;
a scanning line for supplying a selection signal to select the driving circuits in the row direction;
a light emission control line for supplying a light emission control signal to cause the light emitting devices in the row direction to emit light; and
a data line for supplying a current signal designating brightness of the light emitting device to the selected driving circuits,
wherein the driving circuit comprises
a driving transistor which supplies a current to the light emitting device,
a first switch which is arranged between a gate of the driving transistor and the data line, and is turned on in response to the selection signal on the scanning line,
a second switch which is arranged between a drain of the driving transistor and the light emitting device, and is turned on in response to the light emission control signal on the light emission control line,
a first capacitor one end of which is connected to the gate of the driving transistor, and a potential of the other end of which is fixed, and
a second capacitor one end of which is connected to the gate of the driving transistor, and the other end of which is connected to the light emission control line, and
a capacitance ratio of the second capacitor to the first capacitor varies according to the color of the light emitting device to which the driving circuit is connected.

2. A display apparatus according to claim 1, wherein order of magnitude of the capacitance ratios coincides with order of magnitude of a maximum current to be supplied to the light emitting devices.

3. A display apparatus according to claim 1, wherein the current signal which is supplied from the data line to the driving circuit is larger than the current which is supplied from the drain of the driving transistor to the light emitting device according to a voltage held by the first capacitor based on supplying of the current signal.

4. A display apparatus according to claim 1, wherein the second switch is constituted by a transistor which has a channel polarity opposed to a channel polarity of the driving transistor.

5. A display apparatus according to claim 1, wherein the driving circuit further comprises a third capacitor one end of which is connected to the gate of the driving transistor and the other end of which is connected to the scanning line.

6. A display apparatus according to claim 1, wherein the second capacitor is formed by a overlap of a polysilicon layer and a wiring layer constituting the scanning line via an insulating layer, and an overlapping area of the polysilicon layer and the wiring layer varies according to the color of the light emitting device to which the driving circuit is connected.

7. A driving method for a display apparatus which comprises plural light emitting devices arranged in a row direction and a column direction, which emits light of a color selected from plural kinds of colors; a driving circuit connected to each of the plural light emitting devices; a scanning line for supplying a selection signal to select the driving circuits in the row direction; a light emission control line for supplying a light emission control signal to cause the light emitting devices in the row direction to emit light; and a data line for supplying a current signal designating brightness of the light emitting device to the selected driving circuit, wherein the driving circuit comprises a driving transistor which supplies a current to the light emitting device, a first switch which is arranged between a gate of the driving transistor and the data line, and is turned on in response to the selection signal on the scanning line, a second switch which is arranged between a drain of the driving transistor and the light emitting device, and is turned on in response to the light emission control signal on the light emission control line, a first capacitor one end of which is connected to the gate of the driving transistor, and a potential of the other end of which is fixed, and a second capacitor one end of which is connected to the gate of the driving transistor, and the other end of which is connected to the light emission control line, and a capacitance ratio of the second capacitor to the first capacitor varies according to the color of the light emitting device to which the driving circuits connected, the driving method comprising:
holding the current signal on the data line as a voltage in the first capacitor of the driving circuit, by turning on the first switch; and
supplying the current according to the voltage held in the first capacitor from the drain of the driving transistor to the light emitting device, by turning off the first switch and turning on the second switch.

8. A driving method according to claim 7, wherein a change of the signal on the light emission control line before and after turning on the second switch is a change toward a direction of changing a gate-source voltage of the driving transistor to a smaller absolute value via the second capacitor.
